(19) United States
(12) Patent Application Publication
(10) Pub. No.: US 2007/0242312 A1
(43) Pub. Date: Oct. 18, 2007

(54) Image forming apparatus capable of using security code for communication

(75) Inventor: Takahiro Tsutsumi, Toyohashi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/648,687

(22) Filed: Jan. 3, 2007

(30) Foreign Application Priority Data
Mar. 14, 2006 (JP) 2006-069267 (P)

(51) Int. Cl. G06K 15/00

(52) U.S. Cl. 358/3.28

(57) ABSTRACT

On receiving Fax data, an image forming apparatus determines whether or not a security code is superimposed on the Fax image and, if it is superimposed, stores the content of the security code. The Fax image data is stored in a memory or a hard disk drive. The image forming apparatus searches a management code to be input for printing the stored image, on the basis of the read security code. If the management code associated with the stored image is input, the image forming apparatus permits the image to be printed.

This application is based on Japanese Patent Application No. 2006-069267 filed with the Japan Patent Office on Mar. 14, 2006, the entire content of which is hereby incorporated by reference.

### BACKGROUND OF THE INVENTION

1. Field of the Invention

The present invention relates to an image forming apparatus, a method for controlling the image forming apparatus, and a program for controlling the image forming apparatus, and, in particular, to an image forming apparatus capable of using a security code for communication, a method for controlling the image forming apparatus, and a program for controlling the image forming apparatus.

2. Description of the Related Art

Among conventional image forming apparatuses (such as MFP (Multi Function Peripherals) and facsimile apparatuses) having a FAX (facsimile) transmission/reception function, some image forming apparatus have been known to store received managed documents in a storage region (BOX) in a hard disk drive and output the documents, only if a management code is input thereto. The aforementioned function is called confidential printing or the like.

Japanese Laid-Open Patent Publication No. 09-298669 discloses a facsimile apparatus which recognizes data included in a dedicated transmission card transmitted thereto along with a document and, if it determines from the data that the confidentiality of the document should be protected, adds a security code to the image information and stores it in a storage device.

It is also possible to embed a security code such as a tint-block code in image data, in performing FAX transmission. It is desirable that such a security code is constituted by fine dots and the like, in order to prevent the security code from being easily recognized.

With conventional FAX transmitting/receiving methods, a problem has been noted that a FAX document including a security code embedded therein is handled in a manner similar to the normal FAX transmission when reading the FAX document and transmitting the document through a FAX, and it is impossible to manage FAX documents.

### SUMMARY OF THE INVENTION

It is an object of the present invention to provide an image forming apparatus capable of proper document management, a method for controlling the image forming apparatus and a program for controlling the image forming apparatus.

According to an aspect of the present invention, in order to attain the aforementioned object, there is provided an image forming apparatus which receives facsimile information and outputs printed image information, the image forming apparatus including: a security-code reading portion for reading a security code superimposed on received facsimile image information; an image storage portion for storing the image information; and an information management portion for permitting the stored image information to be printed, if information associated with the read security code is input.

According to another aspect of the present invention, there is provided an image forming apparatus which receives facsimile information and outputs printed image information, the image forming apparatus including: a security-information identification portion for identifying security information included in a received facsimile protocol; an image storage portion for storing the image information; an information management portion for permitting the stored image information to be printed, if information associated with the identified security information is input; a security-code creating portion for creating, from the security information, a security code to be printed on the image; and a security-code superimposing portion for superimposing the created security code on the image to be printed.

According to further a different aspect of the present invention, there is provided a method for controlling an image forming apparatus which receives facsimile information and outputs printed image information, the method including: a security-code reading step of reading a security code superimposed on received facsimile image information; an image storage step of storing the image information; and an information management step of permitting the stored image information to be printed, if information associated with the read security code is input.

According to further a different aspect of the present invention, there is provided a method for controlling an image forming apparatus which receives facsimile information and outputs printed image information, the method including: a security-information identification step of identifying security information included in a received facsimile protocol; an image storage step of storing the image information; an information management step of permitting the stored image information to be printed, if information associated with the identified security information is input; a security-code creating step of creating, from the security information, a security code to be printed on the image; and a security-code superimposing step of superimposing the created security code on the image to be printed.

According to the aforementioned inventions, it is possible to provide an image forming apparatus capable of proper document management utilizing security codes, a method for controlling the image forming apparatus, and a program for controlling the image forming apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a FAX transmission image in an MFP.

FIG. 2 is a view illustrating a FAX reception image in the MFP.

FIG. 3 is a block diagram illustrating a hardware structure of the MFP.

FIG. 4 illustrates a functional structure of the MFP

FIG. 5 illustrates a specific example of a security code.

FIG. 6 is a flowchart illustrating facsimile reception processing in the MFP according to a first embodiment.

FIG. 7 is a block diagram illustrating the functional structure of an MFP according to a second embodiment.

FIG. 8 is a flowchart illustrating facsimile reception processing in the MFP according to the second embodiment.

FIG. 9 is a block diagram illustrating the structure of a computer apparatus according to a third embodiment.

### DESCRIPTION OF THE PREFERRED EMBODIMENTS

### First Embodiment

Hereinafter, an MFP according to a first embodiment of the present invention will be described.

The MFP according to the present embodiment is capable of adding a security code (security information) such as a tint-block code to image data, in performing FAX transmission/reception of the image data. An MFP at the reception side reads the security code from the received image data and stores the image in a BOX. Only when a management code associated with the security code is input to an operation panel and the like, the image is permitted to be printed.

With the aforementioned structure, when a document including a security code superimposed thereon is faxed, the MFP at the reception side can treat the document as a managed document, thereby protecting the confidentiality of the information therein.

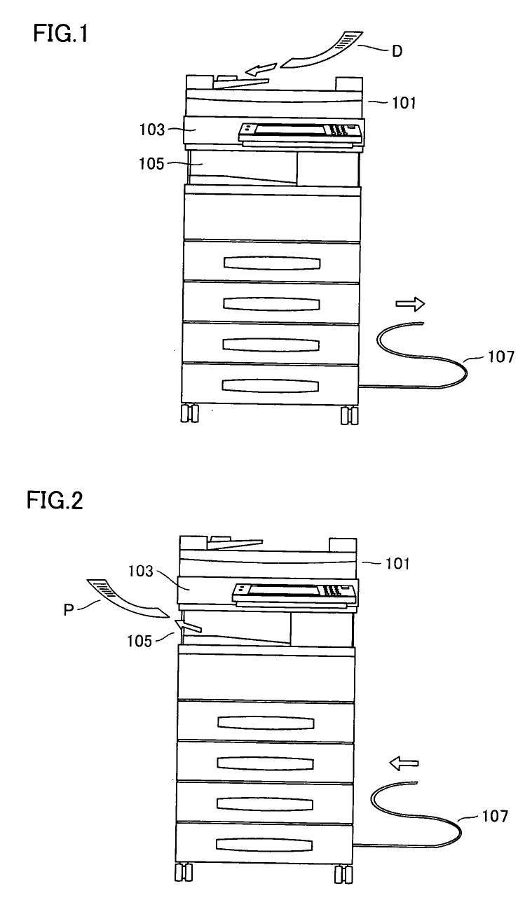

FIG. 1 is a view illustrating an image of FAX transmission in the MFP and FIG. 2 is a view illustrating an image of FAX reception in the MFP.

As illustrated in FIG. 1, during FAX transmission, a document D to be faxed is directly set on the document reading surface of a scanner 103. Also, when the MFP is equipped with an ADF (Auto Document Feeder) and an EDG (Electronic Document Handler) 101, the document D is set in the document suction port thereof to scan the document D. The scanned document is transmitted as a FAX image through a telephone line or an internet line 107.

As illustrated in FIG. 2, image data received through FAX is automatically printed by a print engine 105 or temporally stored in a memory or a hard disk drive and then is printed in response to a command for printing. This results in a printed object P.

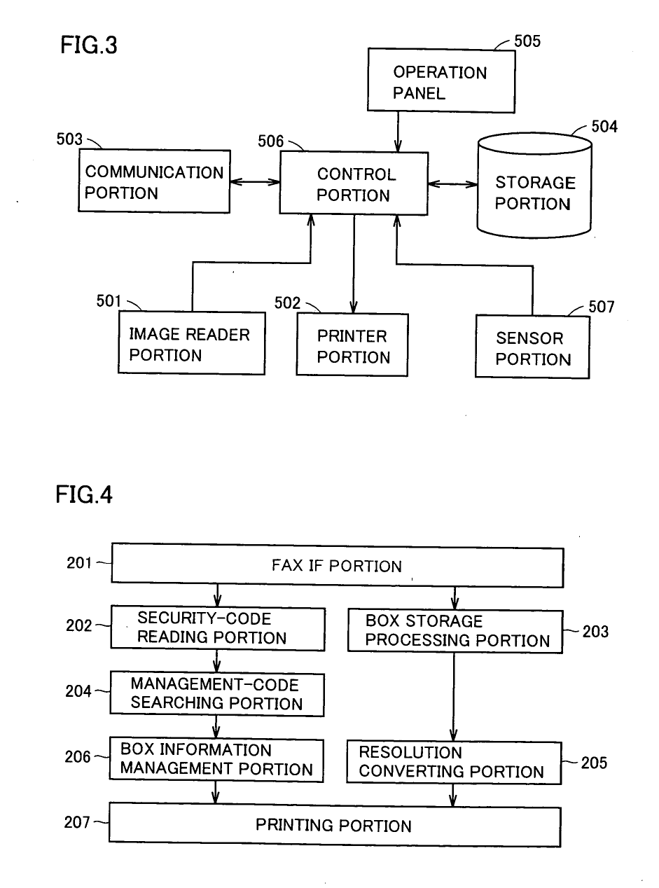

FIG. 3 is a block diagram illustrating the hardware structure of the MFP.

Referring to the figure, the MFP includes a control portion 506 for controlling the entire apparatus, an image reader portion 501 for reading image data from documents, a printer portion 502 for printing images on sheets, a communication portion 503 for performing wireless communication within a short range or connecting the MFP to a network or a telephone line, a storage portion 504 which stores job data and the like, an operation panel 505 which is an interface between the MFP and a user and a sensor portion 507 for detecting the remaining amounts of consumable members.

FIG. 4 is a block diagram illustrating the functional structure of the MFP.

Referring to the figure, the MFP includes a Fax I/F portion 201 for transmitting and receiving facsimile signals, a security-code reading portion 202 for reading the content of a security code included in an image received through the facsimile, a management-code searching portion 204 for searching a management code on the basis of the read security code, a BOX information management portion 206 for monitoring whether or not a management code has been input and, if the management code associated with the image stored in the BOX has been input, permitting the image to be printed, a BOX storage processing portion 203 for storing the received image data in a memory or a hard disk drive, a resolution conversion portion 205 for converting the resolution of the image data and a printing portion 207 for performing printing processing.

FIG. 5 is a view illustrating a concrete example of a security code.

For example, by generating a security code in a unit consisting of 16 dots×16 dots as illustrated in FIG. 5, it is possible to include data of 16×16=256 bits therein, since each single-bit data can be expressed by marking or not marking the corresponding single dot.

Such a security code is repeatedly embedded over the entire surface of an image or a portion thereof (for example, the periphery of a document). As a method for embedding a security code in a portion of a document, there is possibly a method which makes a comparison between the lightness value of the document and a threshold value. Namely, the lightness Y can be determined from RGB values of the document, then the lightness Y can be compared with a threshold value Th, and a security code can be printed on only the portions which satisfy a condition of Y>Th, which enables selectively embedding the security code in the document at portions having higher lightness values and therefore having white grounds. With this processing, a security code is not superimposed on the entire surface of a document, thereby preventing the reduction of the amount of information which is originally included in the document.

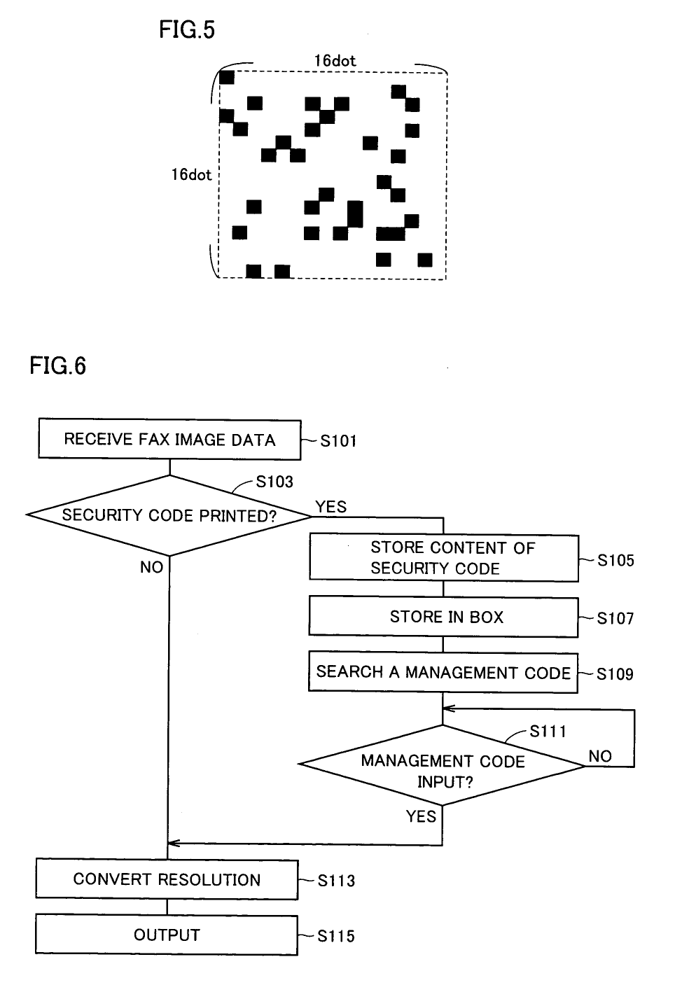

FIG. 6 is a flowchart illustrating facsimile receiving processing in the MFP according to the present embodiment.

At a step S101, Fax I/F portion 201 receives Fax image data. At a step S103, security-code reading portion 202 determines whether or not there is a security code superimposed on the Fax image and, if a security code is superimposed thereon, stores the content of the security code at a step S105. Further, at a step S107, BOX storage processing portion 203 stores the Fax image data in a memory in the BOX or a hard disk drive.

The security code is read by determining the region where the security code is repeatedly provided (16×16 dots in FIG. 5), from the resolution, and recognizing the isolated dot pattern.

At a step S109, management-code searching portion 204 searches, on the basis of the read security code, a management code that is required to be input for printing the Fax image data stored in the BOX. Namely, there are pre-stored, in storage portion 504, plural combinations of security codes and corresponding management codes, and management-code searching portion 204 searches the management code associated with the read security code.

At a step S111, BOX information management portion 206 monitors a management code input through operation panel 505 by the user. If the management code associated with the image stored in the BOX is input, BOX information management portion 206 permits the image to be printed. Then, at a step S113, resolution converting portion 205 converts the Fax image data into image data with a higher resolution. Then, at a step S115, printing portion 207 prints the higher-resolution image data.

Also, if step S103 results in NO, the processing directly proceeds to step S113.

As described above, with the present embodiment, if the MFP receives a facsimile image including a security code superimposed thereon, the MFP does not print the image until a management code associated with the security code has been input. This enables protecting the confidentiality of the information therein.

Further, in the aforementioned embodiment, the MFP searches the management code associated with the security code and, if the management code is input, then prints the image. However, instead thereof, a security code may include information about a management code and the apparatus may be structured to print an image if the management code is input.

### Second Embodiment

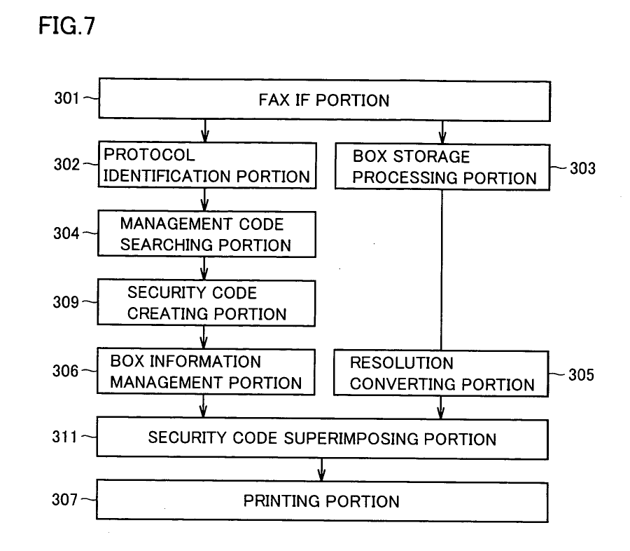

FIG. 7 is a block diagram illustrating the functional structure of an MFP according to a second embodiment.

Referring to the figure, the MFP includes a Fax I/F portion 301 for transmitting and receiving facsimile signals, a protocol identification portion 302 for reading security information included in a facsimile reception protocol, a management-code searching portion 304 for searching a management code on the basis of the read security information, a security-code creating portion 309 for creating a security code from the security information, a BOX information management portion 306 which monitors whether or not a management code has been input and, if a management code associated with an image stored in the BOX has been input, permits the image to be printed, a BOX storage processing portion 303 for storing received image data in a memory or a hard disk drive, a resolution converting portion 305 for converting the resolution of image data, a security-code synthesizing portion 311 for superimposing a security code on the image data having a converted resolution, and a printing section 307 for performing printing processing.

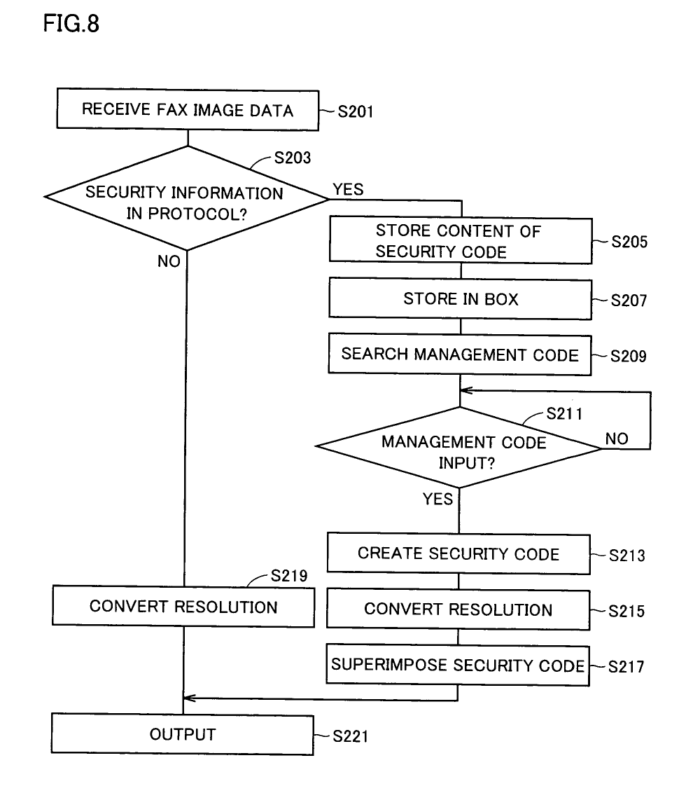

FIG. 8 is a flowchart illustrating facsimile reception processing in the MFP according to the present embodiment.

At a step S201, Fax I/F portion 301 receives Fax image data. At a step S203, protocol identification portion 302 determines whether or not security information is included in the received Fax image data and, if included, stores the security information, at a step S205. At a step S207, BOX storage processing portion 303 stores the Fax image data in a memory in the BOX or a hard disk drive.

At a step S209, on the basis of the read security information, management-code searching portion 304 searches a management code that is required to be input for printing the image stored in the BOX. At a step S211, BOX information management portion 306 monitors the input management code and, if the management code associated with the image stored in the BOX is input, permits the image to be printed.

At a step S213, security-code creating portion 309 creates, from the security information read by the protocol identification portion 302, a security code corresponding thereto. At a step S215, resolution converting portion 305 converts the image into an image with a higher resolution and, at a step S217, security-code synthesizing portion 311 superimposes the security code thereon. Then, at a step S221, the printing portion 307 prints it.

Also, if step S203 results in NO, resolution converting portion 305 converts the image into an image with a higher resolution at a step S219, and the image is printed at a step S221.

Also, both the processing of the flowchart of FIG. 6 and the processing of the flowchart of FIG. 8 may be performed in the MFP.

That is, if a security code is superimposed on a Fax image, the security code is read and the image is stored in the BOX and, if a management code that is the same as that searched on the basis of the security code is input, the image is permitted to be printed. Also, if security information is included in the Fax protocol, the MFP stores the image in the BOX and creates a security code and, if a management code that is the same as that searched on the basis of the security information is input, prints the image including the security code superimposed thereon.

### Third Embodiment

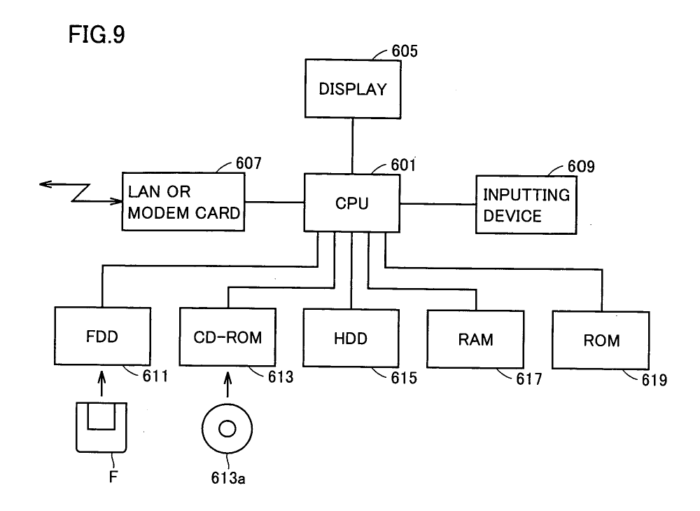

FIG. 9 is a block diagram illustrating the structure of a computer apparatus according to a third embodiment of the present invention.

Referring to the figure, the computer apparatus includes a CPU 601 for controlling the entire apparatus, a display 605, a LAN (local area network) card 607 (or a modem card) for connecting the apparatus to a network or communicating with the outside, an inputting device 609 constituted by a keyboard and a mouse and the like, a flexible disk drive 611, a CD-ROM drive 613, a hard disk drive 615, a RAM 617 and a ROM 619.

Flexible disk drive 611 is capable of reading data such as programs and images recorded on a flexible disk F, and CD-ROM drive 613 is capable of reading data such as programs and images recorded on a CD-ROM 613a.

The programs execute the processes illustrated in the aforementioned flowcharts for processing received image data or performing FAX transmission.

### Effects of Embodiments

As described above, with the embodiments of the present invention, when the MFP receives an image including a security code superimposed thereon, only if a management code associated with the security code is input thereto, the image is permitted to be output, which can enhance the confidentiality of the received data. Also, information about a security code may be embedded in the protocol, which enables an image forming apparatus at the reception side to superimpose the security code on an image and then print the image or enables the image forming apparatus at the reception side to output the image only if the management code is input thereto, which can enhance the confidentiality of the received data.

### Others

Also, the processes according to the aforementioned embodiments may be executed with software or hardware circuits.

Further, programs which execute the processes of the flowcharts according to the aforementioned embodiments may be provided. Also, such programs may be recorded in a recording medium such as a CD-ROM, a flexible disk, a hard disk, a ROM, a RAM, a memory card, and the recording medium may be provided to a user. Also, such programs may be downloaded to the apparatus through a communication line such as the internet.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus which receives facsimile information and outputs printed image information, the image forming apparatus comprising:
a security-code reading portion for reading a security code superimposed on received facsimile image information;
an image storage portion for storing said image information; and
an information management portion for permitting said stored image information to be printed, if information associated with said read security code is input.

2. The image forming apparatus according to claim 1, further comprising a management-code searching portion for searching a management code associated with said read security code, out of stored management codes, wherein said information management portion permits the stored image information to be printed, if said management code associated with the security code is input.

3. The image forming apparatus according to claim 1, further comprising:
a security-information identification portion for identifying security information included in a received facsimile protocol, wherein said information management portion permits said stored image information to be printed, if information associated with said identified security information is input;
a security-code creating portion for creating, from the security information, a security code to be printed on the image; and
a security-code superimposing portion for superimposing said created security code on the image to be printed.

4. An image forming apparatus which receives facsimile information and outputs printed image information, the image forming apparatus comprising:
a security-information identification portion for identifying security information included in a received facsimile protocol;
an image storage portion for storing said image information;
an information management portion for permitting said stored image information to be printed, if information associated with said identified security information is input;
a security-code creating portion for creating, from said security information, a security code to be printed on the image; and
a security-code superimposing portion for superimposing said created security code on the image to be printed.

5. The image forming apparatus according to claim 4, further comprising a management-code searching portion for searching a management code associated with said read security information, out of stored management codes, wherein said information management section permits the stored image information to be printed, if the management code associated with the security information is input.

6. A method for controlling an image forming apparatus which receives facsimile information and outputs printed image information, the method including:
a security-code reading step of reading a security code superimposed on received facsimile image information;
an image storage step of storing said image information; and
an information management step of permitting said stored image information to be printed, if information associated with said read security code is input.

7. A method for controlling an image forming apparatus which receives facsimile information and outputs printed image information, the method including:
a security-information identification step of identifying security information included in a received facsimile protocol;
an image storage step of storing said image information;
an information management step of permitting said stored image information to be printed, if information associated with said identified security information is input;
a security-code creating step of creating, from said security information, a security code to be printed on the image; and
a security-code superimposing step of superimposing said created security code on the image to be printed.

8. A program product for controlling an image forming apparatus which receives facsimile information and outputs printed image information, the program being adapted to cause a computer to execute:
a security-code reading step of reading a security code superimposed on received facsimile image information;
an image storage step of storing said image information; and
an information management step of permitting said stored image information to be printed, if information associated with said read security code is input.

9. A program product for controlling an image forming apparatus which receives facsimile information and outputs printed image information, the program being adapted to cause a computer to execute:
a security-information identification step of identifying security information included in a received facsimile protocol;
an image storage step of storing said image information;
an information management step of permitting said stored image information to be printed, if information associated with said identified security information is input;
a security-code creating step of creating, from said security information, a security code to be printed on the image; and
a security-code superimposing step of superimposing said created security code on the image to be printed.
